(19) United States
(12) Patent Application Publication
(10) Pub. No.: US 2017/0270483 A1
(43) Pub. Date: Sep. 21, 2017

(54) Systems, Methods and Computer Program Products for Providing Automated Personnel Management Services

(71) Applicant: SignlnPlus, LLC, San Antonio, TX (US)

(72) Inventor: James Joseph Petersen, Valdosta, GA (US)

(21) Appl. No.: 15/461,085

(22) Filed: Mar. 16, 2017

Related U.S. Application Data
(60) Provisional application No. 62/309,003, filed on Mar. 16, 2016.

(51) Int. Cl. G06Q 10/10; G06Q 50/26

(52) U.S. Cl. CPC G06Q 10/105; G06Q 50/26

(57) ABSTRACT

A personnel management system is disclosed.

### RELATED APPLICATION

The present application claims the benefit of and priority to U.S. Provisional Patent Application No. 62/309,003, filed Mar. 16, 2016, entitled “Systems, Methods and Computer Program Products for Providing Automated Personnel Management Services,” the disclosure of which is hereby incorporated herein by reference in its entirety.

### FIELD OF INVENTION

The present invention relates to computer networks and, more particularly, to computer networks that provide automated personnel management services.

### BACKGROUND

Large governmental and corporate organizations may include vast numbers of personnel such as employees and/or members. Examples of such organizations may include large national and multinational corporations, large civilian governmental organizations and military organizations such as different branches of the armed services. For example, the US Army, the US Air Force, the US Navy and the US Coast guard may each include large numbers of personnel. Additionally, in the context of armed services branches, retired and/or dependents of members may also be included.

Managing personnel data and human resource needs corresponding to the personnel may require many different processes and/or operations that may include multiple different data sources. Such processes and/or operations may rely on many different people to access multiple databases and may rely on many different software applications to perform the processes and/or operations. In some instances, while such operations may include and/or require personnel-specific data and/or service, many processes and/or operations include elements that are common to one another.

Embodiments of the present invention are, therefore, directed towards solving these and other related problems.

### BRIEF DESCRIPTION OF THE DRAWINGS

The accompanying figures are included to provide a further understanding of the present invention, and are incorporated in and constitute a part of this specification. The drawings illustrate some embodiments of the present invention and, together with the description, serve to explain principles of the present invention.

FIGS. 1a-1c are block diagrams illustrating example networks in which operations for monitoring and reporting network application performance may be performed according to some embodiments of the present invention.

FIG. 2 is a block diagram illustrating a system or computer program code for providing automated personnel services management using one or more computing devices as discussed above according to some embodiments of the present invention.

FIG. 3 is a block diagram illustrating operations, components and/or computer program code modules that may be included in the system access hub according to some embodiments of the present invention.

FIG. 4 is a block diagram illustrating operations, components and/or computer program code modules that may be included in a lobby sign-in tool according to some embodiments of the present invention.

FIG. 5 is a block diagram illustrating operations, components and/or computer program code modules that may be included in customer service “next customer” screens according to some embodiments of the present invention.

FIG. 6 is a block diagram illustrating operations, components and/or computer program code modules that may be included in administrative services module according to some embodiments of the present invention.

FIG. 7 is a block diagram illustrating operations, components and/or computer program code modules that may be included in the personnel data tracker according to some embodiments of the present invention.

FIG. 8 is a block diagram illustrating operations, components and/or computer program code modules that may be included in the awards and decorations module according to some embodiments of the present invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail. While various modifications and alternative forms of the embodiments described herein may be made, specific embodiments are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification are taken to specify the presence of stated features, steps, operations, elements, and/or components, but do not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items, and may be abbreviated as “/”.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art, and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another.

Example embodiments are described below with reference to block diagrams and/or flowchart illustrations of methods, apparatus (systems and/or devices), and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process, such that the instructions, which execute on the computer or other programmable apparatus, provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a non-transitory computer-usable or computer-readable storage medium having computer-usable or computer-readable program code embodied in the medium for use by or in connection with an instruction execution system. In the context of this document, a non-transitory computer-usable or computer-readable medium may be any medium that can contain, store, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable compact disc read-only memory (CD-ROM).

Computer program code for carrying out operations of data processing systems discussed herein may be written in a high-level programming language, such as C, C++, or Java, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

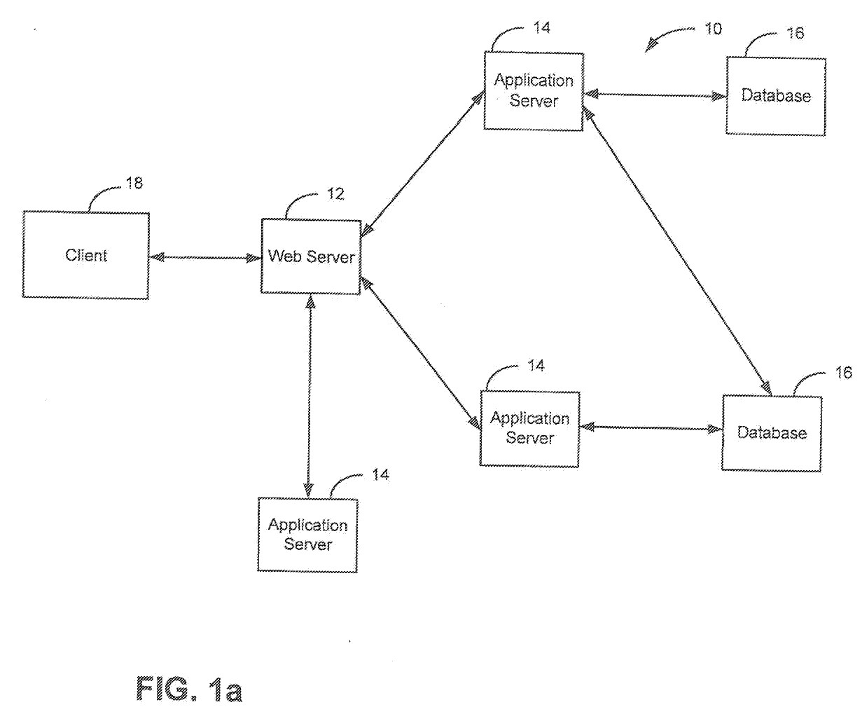

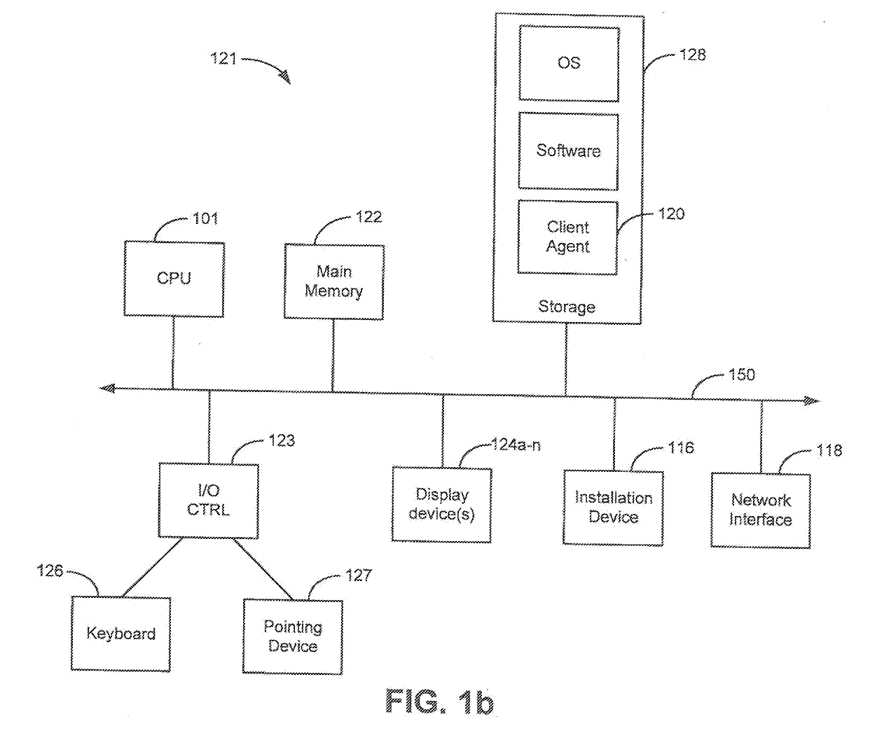

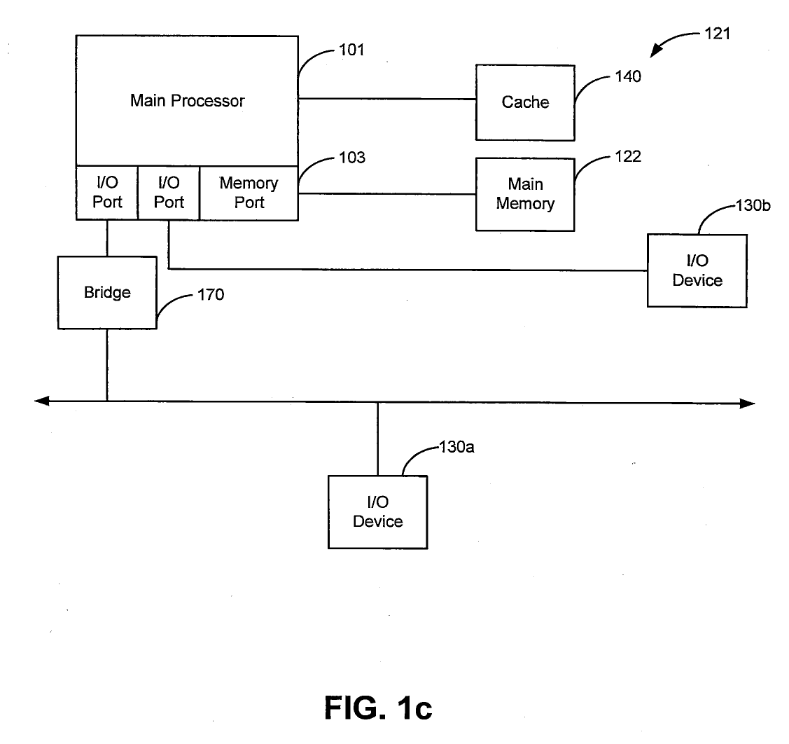

Reference is made to FIGS. 1a-1c, which are block diagrams illustrating example networks in which operations for monitoring and reporting network application performance may be performed according to some embodiments of the present invention.

Referring to FIG. 1 a, an example network 10 may include a web server 12, one or more application servers 14 and one or more database servers 16. Although not illustrated, a network 10 as used herein may include directory servers, security servers, and/or transaction monitors, among others. The web server 12 may be a computer and/or a computer program that is responsible for accepting HTTP requests from clients 18 (e.g., user agents such as web browsers) and serving them HTTP responses along with optional data content, which may be, for example, web pages such as HTML documents and linked objects (images, etc.). An application server 14 may include a service, hardware, and/or software framework that may be operable to provide one or more programming applications to clients in a network. Application servers 14 may be coupled to one or more web servers 12, database servers 16, and/or other application servers 14, among others. Some embodiments provide that a database server 16 may include a computer and/or a computer program that provides database services to other computer programs and/or computers as may be defined, for example by a client-server model, among others. In some embodiments, database management systems may provide database server functionality.

Some embodiments provide that the systems and computer program products as described herein may reside on ones of the web server(s) 12, application servers 14 and/or database servers 16, among others. In some embodiments, one or more components of the systems and computer program products for providing automated personnel management services may reside in a dedicated computing device that is coupled to the network 10.

Web server(s) 12, application servers 14 and/or database servers 16 may be deployed as and/or executed on any type and form of computing device, such as a computer, network device, or appliance capable of communicating on any type and form of network and performing the operations described herein. FIGS. 1b and 1c depict block diagrams of a computing device 121 useful for practicing some embodiments described herein. Referring to FIGS. 1b and 1c, a computing device 121 may include a central processing unit 101 and a main memory unit 122. A computing device 121 may include a visual display device 124, a keyboard 126, and/or a pointing device 127, such as a mouse. Each computing device 121 may also include additional optional elements, such as one or more input/output devices 130a-130b (generally referred to using reference numeral 130), and a cache memory 140 in communication with the central processing unit 101.

The central processing unit 101 is any logic circuitry that responds to and processes instructions fetched from the main memory unit 122. In many embodiments, the central processing unit 101 is provided by a microprocessor unit, such as: those manufactured by Intel Corporation of Mountain View, Calif.; those manufactured by Motorola Corporation of Schaumburg, Ill.; the POWER processor, those manufactured by International Business Machines of White Plains, N.Y.; and/or those manufactured by Advanced Micro Devices of Sunnyvale, Calif. The computing device 121 may be based on any of these processors, and/or any other processor capable of operating as described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM), among others. The main memory 122 may be based on any of the above described memory chips, or any other available memory chips capable of operating as described herein. In some embodiments, the processor 101 communicates with main memory 122 via a system bus 150 (described in more detail below). In some embodiments of a computing device 121, the processor 101 may communicate directly with main memory 122 via a memory port 103. Some embodiments provide that the main memory 122 may be DRDRAM.

FIG. 1c depicts some embodiments in which the main processor 101 communicates directly with cache memory 140 via a secondary bus, sometimes referred to as a backside bus.

In some other embodiments, the main processor 101 may communicate with cache memory 140 using the system bus 150. Cache memory 140 typically has a faster response time than main memory 122 and may be typically provided by SRAM, BSRAM, or EDRAM. In some embodiments, the processor 101 communicates with various I/O devices 130 via a local system bus 150. Various busses may be used to connect the central processing unit 101 to any of the I/O devices 130, including a VESA VL bus, an ISA bus, an EISA bus, a MicroChannel Architecture (MCA) bus, a PCI bus, a PCI-X bus, a PCI-Express bus, and/or a NuBus, among others. For embodiments in which the I/O device is a video display 124, the processor 101 may use an Advanced Graphics Port (AGP) to communicate with the display 124. FIG. 1c depicts some embodiments of a computer 100 in which the main processor 101 communicates directly with I/O device 130 via HyperTransport, Rapid I/O, or InfiniBand. FIG. 1c also depicts some embodiments in which local busses and direct communication are mixed: the processor 101 communicates with I/O device 130a using a local interconnect bus while communicating with I/O device 130b directly.

The computing device 121 may support any suitable installation device 116, such as a floppy disk drive for receiving floppy disks such as 3.5-inch, 5.25-inch disks, or ZIP disks, a CD-ROM drive, a CD-R/RW drive, a DVD-ROM drive, tape drives of various formats, USB device, hard disk drive (HDD), solid-state drive (SSD), or any other device suitable for installing software and programs such as any client agent 120, or portion thereof The computing device 121 may further comprise a storage device 128, such as one or more hard disk drives or solid-state drives or redundant arrays of independent disks, for storing an operating system and other related software, and for storing application software programs such as any program related to the client agent 120. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 121 may include a network interface 118 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., ISDN, Frame Relay, ATM), wireless connections (e.g., IEEE 802.11), or some combination of any or all of the above. The network interface 118 may comprise a built-in network adapter, network interface card, PCMCIA network card, card bus network adapter, wireless network adapter, USB network adapter, modem, or any other device suitable for interfacing the computing device 121 to any type of network capable of communication and performing the operations described herein. A wide variety of I/O devices 130a-130n may be present in the computing device 121. Input devices include keyboards, mice, trackpads, trackballs, microphones, and drawing tablets, among others. Output devices include video displays, speakers, inkjet printers, laser printers, and dye-sublimation printers, among others. The I/O devices 130 may be controlled by an I/O controller 123 as shown in FIG. 1c. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 121 may provide USB connections to receive handheld USB storage devices such USB flash drives.

In some embodiments, the computing device 121 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable, or provide for the connection and use of multiple display devices 124a-124n by the computing device 121. For example, the computing device 121 may include any type and/or form of video adapter, video card, driver, and/or library to interface, communicate, connect or otherwise use the display devices 124a-124n. In some embodiments, a video adapter may comprise multiple connectors to interface to multiple display devices 124a-124n. In some other embodiments, the computing device 121 may include multiple video adapters, with each video adapter connected to one or more of the display devices 124a-124n. In some embodiments, any portion of the operating system of the computing device 100 may be configured for using multiple displays 124a-124n. In some embodiments, one or more of the display devices 124a-124n may be provided by one or more other computing devices connected to the computing device 121, for example, via a network. Such embodiments may include any type of software designed and constructed to use another computer's display device as a second display device 124a for the computing device 121. One ordinarily skilled in the art will recognize and appreciate the various ways and embodiments that a computing device 121 may be configured to have multiple display devices 124a-124n.

In further embodiments, an I/O device 130 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, and/or a Serial Attached small computer system interface bus, among others.

A computing device 121 of the sort depicted in FIGS. 1b and 1c may typically operate under the control of operating systems, which control scheduling of tasks and access to system resources. The computing device 121 can be running any operating system such as any of the versions of the Microsoft® Windows operating systems, any of the different releases of the Unix and Linux operating systems, any version of the Mac OS® for Macintosh computers, any embedded operating system, any real-time operating system, any open source operating system, any proprietary operating system, any operating systems for mobile computing devices, and/or any other operating system capable of running on a computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS VISTA, WINDOWS 7.0, WINDOWS SERVER 2003, WINDOWS 10 and/or WINDOWS SERVER 2008, among others, all of which are manufactured by Microsoft Corporation of Redmond, Wash.; MacOS and/or IOS, manufactured by Apple Computer of Cupertino, Calif.; OS/2, manufactured by International Business Machines of Armonk, N.Y.; and Linux, a freely-available operating system distributed by Red Hat of Raleigh, N.C., among others, or any type and/or form of a Unix operating system, among others.

In some embodiments, the computing device 121 may have different processors, operating systems, and input devices consistent with the device. For example, in one embodiment the computing device 121 is a smart phone manufactured by Apple Computer, Samsung or Palm, Inc. In this embodiment, the smart phone is operated under the control of the operating system and includes a stylus input device as well as a five-way navigator device. Moreover, the computing device 121 can be any workstation, desktop computer, laptop, or notebook computer, server, handheld computer, mobile telephone, any other computer, or other form of computing or telecommunications device that is capable of communication and that has sufficient processor power and memory capacity to perform the operations described herein.

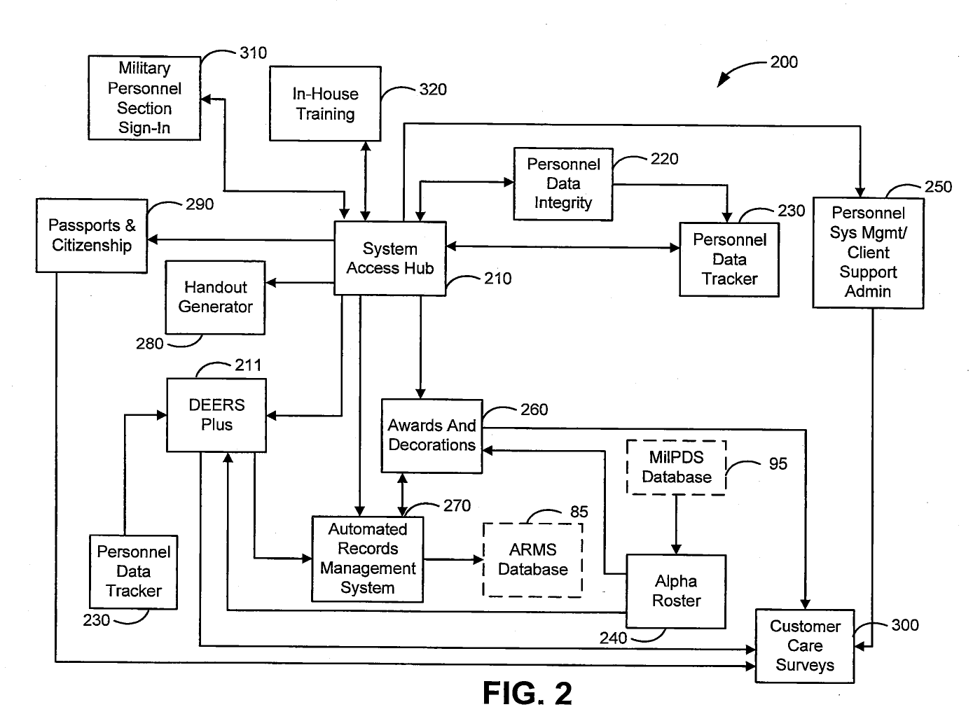

Reference is now made to FIG. 2, which is a block diagram illustrating a system or computer program code for providing automated personnel services management using one or more computing devices as discussed above according to some embodiments of the present invention. As discussed above, blocks as illustrated herein may be representative of computer program code that, when executed by a processor, cause the processor to perform operation described herein. Since a military branch may represent a particularly complex organization, based on the members, retirees, and dependents, the command structures, award/decoration programs, and the extensive benefits programs, the system 200 herein will be described in the context of a military branch. However, such example is non-limiting as many of the system components described herein are applicable to address issues with non-military government organizations and/or large corporations among others.

The system 200 may include a system access hub 210 that is configured to receive input data that corresponds to specific service requests by customers. In the current example, customers may include any appropriated and nonappropriated civilians, contractors, active or inactive duty personnel, reservists, guard, retirees and/or dependents thereof. Additionally, users may include system administrators corresponding to an information technology (IT) professional and/or organizational representatives such, as, for example, human resource technicians. As used herein, users may provide inputs to the system based on services provided to and/or requested by customers. Some embodiments provide that a customer may also be a user in the context that customers may be using one or more of the modules and/or programs directly. In some embodiments, the system access hub 210 may be a launch pad for all of the other modules. Some embodiments provide that a single one of the modules and/or programs described herein and/or multiple ones of the modules and/or programs described herein may be loaded onto a user's computer. For example, a person in charge of promotions may only have the Military Personnel Section Sign-In module (310, FIG. 2) and/or the alpha roster (240, FIG. 2) loaded onto his/her computer. In some embodiments, the system access hub 210 may also loaded onto a user's computer and may be used to access any and/or all of the other modules and/or programs.

In the context of the military branch example, a defense enrollment eligibility reporting system (DEERS) Plus module 211 may track military identification card functions and other customer service related functions. The DEERS Plus module 211 may also provide a customer sign-in tool to better manage the flow of customers and may be used to track the types of services provided by military Personnel (HR representatives) and automatically solicit customer feedback, via e-mail, after the customer is served. Some embodiments provide that the DEERS Plus module 211 may track all job responsibilities of customer service personnel (e.g., system down time, ID cards retrieved, unrecovered identification cards) and can generate a plurality of different reports to identify customer traffic and trends. Some embodiments provide that the DEERS Plus module 211 automatically generates letters and notification e-mail. Once the customer finishes signing in for service, the customer can see his or her estimated “wait time” as well as see his or her name on the list of customers waiting for service.

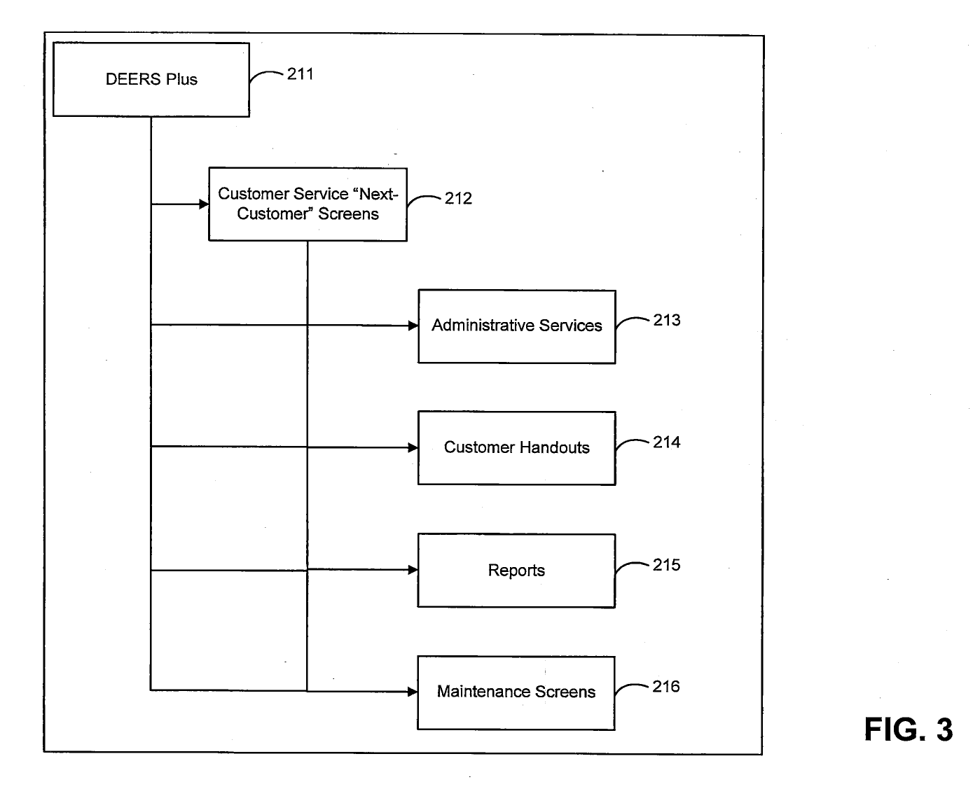

Reference is now made to FIG. 3, which is a block diagram illustrating operations, components and/or computer program code modules that may be included in the DEERS Plus module 211 according to some embodiments of the present invention. A lobby sign-in tool 211 may include one or more graphical user interfaces that may receive data inputs corresponding to a customer. For example, a customer may be asked if he has his previous military identification card. If the customer response is negative then a lost/stolen ID card procedure may be outlined. If the customer wants to know what documents are required to update a marital and/or family status, a list of requisite documents may be provided.

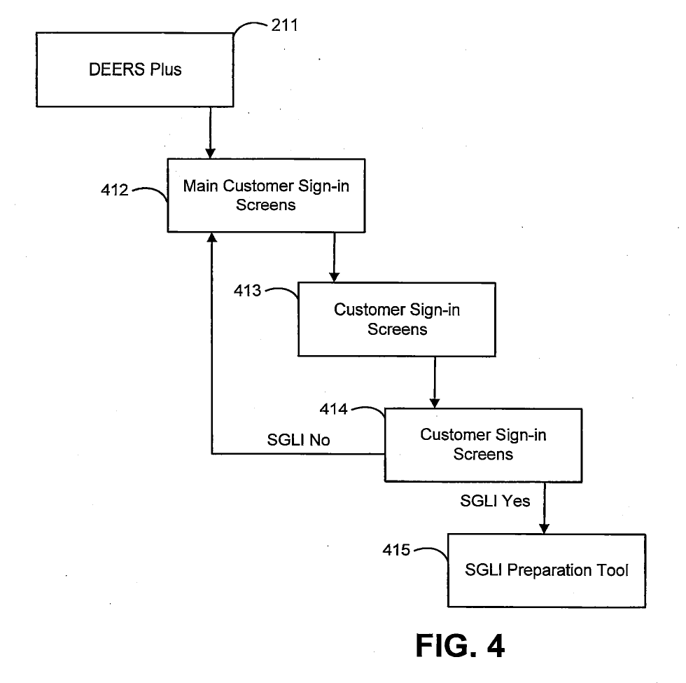

Reference is now made to FIG. 4, which is a block diagram illustrating operations, components and/or computer program code modules that may be included in the DEERS Plus module 211 according to some embodiments of the present invention. In some embodiments, the data inputs may be received from a user on behalf of the customer. Some embodiments provide that the customer may input the data via the DEERS Plus module 211. The customer data may include identification data that may be used by an automated personnel identification system. For example, some embodiments collect, analyze and/or determine how HR technicians may update one or more records in the real-time automated personnel identification system to include beneficiary data and issue various customer services identification privilege cards. Examples of such cards include various uniformed services identification and privilege cards, among others.

Some embodiments provide that once a customer signs into the computer in the lobby, one or more screens and/or monitors may show all customers waiting for service. In some embodiments, individual customers may be listed for each section separately to give the customer a better idea as to the wait time. Once a customer signs in, that customer's name may appear on the computer screen(s) of the corresponding military personnel system (MPS) section. For example, if a customer signed in for a Force Management action, then the customer will only appear, as waiting to be served, on the computers in the Force Management section. This is because each section may manage their own customers.

If a customer stays in the queue for longer than a defined waiting time (e.g., 15 minutes), a delay indicator may appear reminding him or her that a customer has been in the queue for more than the defined delay threshold corresponding to the waiting time. For example, the delay indicator may include a graphical indicator that is colored yellow and/or some other color and/or pattern indicating the customer has been waiting longer than the delay threshold. In some embodiments, multiple delay thresholds may be defined to indicate multiple levels of delay. For example, after a delay that exceeds a second defined delay threshold may cause a second delay indicator to appear reminding him or her that the customer has been waiting longer than the second delay threshold. For example, the second delay indicator may include a graphical indicator that is colored red and/or some other color and/or pattern indicating that the customer has been in the queue for more than the second defined delay threshold.

Responsive to receiving data from the customer, a series of decision logic screens may be presented to the customer to educate the customer. In some embodiments, the service desk may be selected from a plurality of service desks based on the service request by the customer. For example, main customer sign-in screens 412 may receive service identification data that identifies the service that is being requested by the customer. The second customer sign in screen 413 may receive data corresponding to a general service requested by the customer. Responsive to receiving the data corresponding to the general service, detail customer sign in screen 414 may be provided and configured to receive information corresponding to details on the requested service. In some embodiments, depending on type of service requested, one or more education screens may be provided to the customer.

Some embodiments provide that additional services may be requested and/or required. For example, if a customer provides input data indicating that a special service, such as, for example, a service corresponding to the service members group life insurance (SGLI) program, a service specific screen, such as an SGLI preparation tool 415 may be provided. The SGLI preparation tool 415 may be activated if the customer requests a new SGLI form, which may be substantially automatically populated by another of the modules in the system, such as, for example, the alpha roster (FIG. 2, 240). In response, an SGLI form may be generated and/or provided to the customer, circumstance specific unusual beneficiary letters and/or spouse letters may be generated and/or provided, and/or a message may be generated and sent to a user for additional actions.

In some embodiments, the SGLI preparation tool 415 receives input from the customer so the customer can complete his or her SGLI form in the lobby before he is called for service. The form has a series of decision logic education screens. The SGLI preparation tool is module imports relevant data from the Alpha Roster (e.g., grade, name, current SGLI amount and address) to speed up the completion process. There are also a series of “intuitive” screens based on the member's responses to various questions. In addition to producing a completed SGLI form, the module creates mandatory unusual beneficiary letters for the member's signature and creates a list of actions the technician must act on based on the responses of the customer (e.g., change address in the military personnel data system (MilPDS), prepare spouse notification letter, etc.)

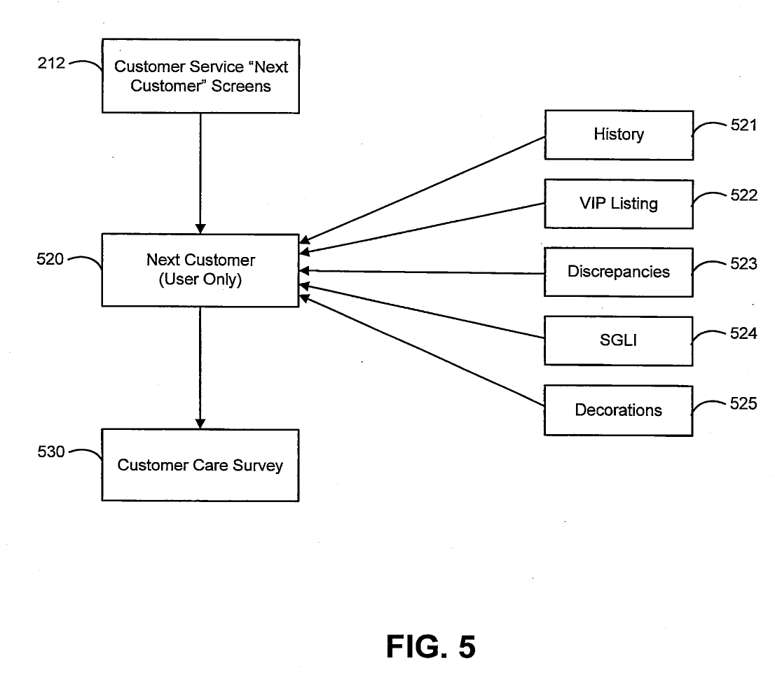

Once the customer finishes signing in for service, the customer can see his or her estimated “wait time” and/or his or her name on the list of other customers waiting for services via customer service “next customer” screens 212. For example, reference is now made to FIG. 5, which is a block diagram illustrating operations, components and/or computer program code modules that may be included in customer service “next customer” screens 212 according to some embodiments of the present invention.

The customer service “next customer” screens 212 may include a next customer user only screen 520 that is provided to the user and that includes information regarding the customer and/or the request for service from the customer. For example, information may include a narrative customer history 521 (e.g., previous interactions with the customer), whether the customer is a VIP or other priority customer 522, any discrepancies 523 in the customer record and/or the request for service, SGLI data 552 and/or decorations 525, among others.

In some embodiments, a customer care survey module 530 may automatically generate and send customer care surveys to customers. Generating the customer care surveys 530 may include generating the surveys based on information corresponding to the service requested and/or provision of such service. The customer care survey module (FIG. 2, 300) may receive survey data from customers, analyze the received data and provide customer survey data and/or generate customer survey reports corresponding to the customer survey data.

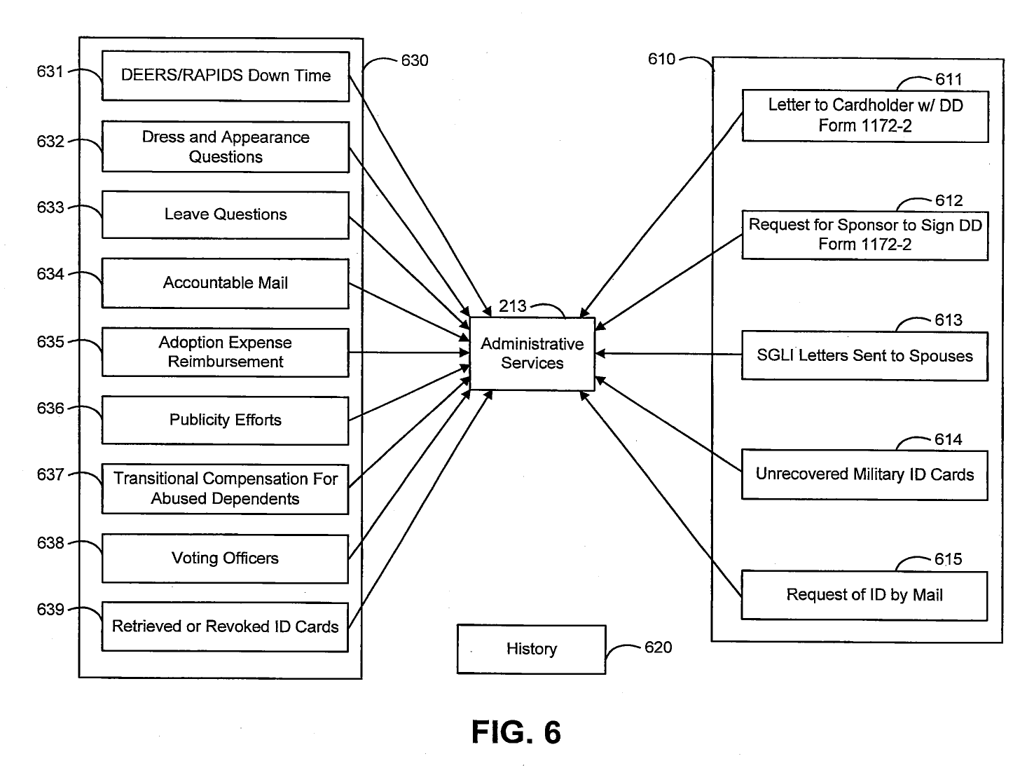

Some embodiments include an administrative services screen 213 that provides an interface for separate sign in for a user such as, the customer service technician. For example, brief reference is made to FIG. 6, which is a block diagram illustrating operations, components and/or computer program code modules that may be included in administrative services module according to some embodiments of the present invention.

Administrative services notifications 212 may notify the user of a priority customer such as a VIP (e.g., commanding officer) so this customer may be served relatively immediately. The user may also be notified if a customer has an unresolved personal data discrepancy, such as the family status change that has not been updated accurately. In some embodiments, a Personnel Data Tracker information system 230 may be accessed and/or communicatively coupled. In this regard, at a push of a button, the technician can read an open discrepancy, then the system may generate a reminder regarding the discrepancy or close out the open discrepancy if the member signed in to fix the problem. Some embodiments provide that the discrepancy can be automatically resolved based on input from the user, while in some embodiments the user may be directed how to resolve the discrepancy. The technician may be informed what actions he or she should take to ensure DEERS and MilPDS are correct. For example, if the customer is an unmarried widow/widower, then the technician serving the customer is alerted (popup window) to provide the customer with an “Impact of Remarrying” handout. In some embodiments, a plurality of handouts 280 may be provided that address a host of different issues (e.g., marriage, divorce, dependency determinations, Guard and Reserve issues, etc.). If the customer is coming in from an overseas location, then the technician is alerted to retrieve no-fee passports from the customer. Some embodiments provide that multiple other graphical user interface elements may be provided to inform the user what action to take. Some embodiments provide that customer feedback may be automatically solicited by automatically generating and sending one of more e-mail messages after the customer is served.

In some embodiments, the administrative services screen 213 may be used to cause an automated and personalized letter program 610 to generate a plurality of different types of letters. For example, a letter to cardholder with a DD Form 1172-2 611 may be sent to a family member and/or custodial parent based on receiving information from the user that a family member needs an ID card. A request to sponsor letter 612 may be sent to a military sponsor based on receiving a report that a military member will not sign a form for a family member. An SGLI letter sent to a spouse 613 may be sent to a spouse to comply with legal requirements. Unrecovered military ID card letters 614 may be sent to cardholders, security offices, exchanges, and/or commissaries. For example, a family member may have, but not be entitled to an ID card. A request for ID by mail letter 615 that includes information regarding obtaining an ID card may be sent to a cardholder who cannot appear in person for the ID card, In some embodiments, personalized letters are tailored depending on the circumstances of the situation as annotated in the system.

In some embodiments, the administrative services module may provide a consumables interface 620 that is used to track inventory corresponding to stock levels of supplies such as, for example, ribbons, laminating materials, and/or ID card stock, among others. Some embodiments provide that an administrative services module may interact with a variety of forms to capture information and/or data to identify an action performed and/or for tracking performance. Examples include, but are not limited to DEERS/RAPIDS down time 631, dress and appearance questions 632, leave questions 633, accountable mail 634, adoption expense reimbursement 635, publicity efforts 636, transitional compensation for abused dependents 637, voting officers 638 and/or retrieved or revoked ID cards 639, among others.

Some embodiments provide that all job responsibilities of users (i.e., customer service personnel) may be tracked. For example, performance metrics including system down time, ID cards retrieved, unrecovered identification cards, tracks accountable mail, adoption expense reimbursement program, DEERS consumables, DEERS down time, dress and appearance questions, leave questions, publicity efforts, and/or transitional compensation for abused dependents, among others, may be tracked.

Additionally, a customer handouts interface 214 may use data supplied by the customer, the user and/or a system owner and/or sponsor to generate and provide hardcopy handouts that include information for customers and that may be provided responsive to specific requests for information by a customer. In some embodiments, the handouts interface 214 may interact with and/or be a component of a handout generator 280. Examples of handouts that may be automatically generated include reserve and guard issues, adding a child born out of wedlock, requesting an ID card by mail, common access cards, common problems and solutions, marriage, divorce, ward dependency determination, parent dependency determination, finding people and records, full-time students, disabled veterans and/or power of attorney, among others.

Some embodiments provide that the reports interface 215 may use data supplied by the customer, the user and/or the system owner and/or sponsor to generate one or more reports corresponding to customer input data. In some embodiments, such reports may include digital and/or hardcopy reports that may be provided to other organization personnel for trend analysis and/or leadership the different organizational levels. For example, reports may identify customer traffic and trends such as average wait time, quantity of customers served for a given period of time, summaries of types of services provided, passport retrieval, peak times in customer service, reasons for issuance of identification cards, lost/stolen identification cards and/or number of service actions currently being processed, among others. Such reports may identify patterns of work flow, problem customers that should be treated differently and/or inform the requirement for support staff. Examples of types of data that may be captured in these reports include: average wait time per day or several days as specified by the user to measure daily, monthly and annual customer patterns; specific types of customer services rendered per day or period of time as specified by the user; customers served and services provided by each HR technician; passport retrieval actions for military members inbound from overseas locations; customer service peak times segregated by hour to identify when and how to allocate customer service personnel; status of personnel served (e.g., retired, active duty, appropriated funded civilians, etc.) and types of services rendered, which is used as an audit tool; individuals updating life insurance, which is used as an audit tool with Servicemembers Group Life Insurance (SGLI) forms mailed to the Air Force Personnel Center; military identification (ID) card transaction reports assess how quickly ID cards are produced to include the time the customer reported for service, the time the customer was served and the time the ID card was completed; reasons why ID cards are issued so unit leadership and the Office of Special Investigations can be informed of negative trends discovered during audits; types of Defense Eligibility and Enrollment System (DEERS) transactions so unit leadership can be notified of marital status and family member changes; and identify newly inprocessed first-term airmen so that a decoration review and update and be performed.

Maintenance screens 216 may be used to receive data inputs from users for updating, supplementing, revising and/or correcting reference data in one or more system databases. Maintenance screens 216 may receive information from users that may be used to update other screens and/or reports. In some embodiments, the data in maintenance screen tables may be used to update forms and/or may be used in computation performed for generating reports. For example, when computing how many days it took to perform an update, non-work days may be deducted from the report based on a non-work days table. Tables that may be updated using the maintenance screens include those corresponding to technicians, grades and titles, SGLI technicians, referral agencies, reasons for a new ID card, reasons for DEERS update, units served, VIP listing, non-work days, and/or alpha roster updates, among others.

Referring back to FIG. 2, the system 200 may include a military personnel section (MPS) sign-in module 310. The MPS sign-in module 310 may be similar to the DEERS Plus module 211, however, it may primarily be used as a sign-in module to control the flow of customers to the various MPS work centers. The MPS sign-in module 310 may be used by multiple different sections, including, for example, career development, force management and/or customer support, to monitor and track customers from one central sign-in location.

The MPS sign-in module 310 may include a series of customer display screens. For example, if the MPS is closed due to training, or some other event, then the customer may be prevented from signing in unless they have an appointment. Some embodiments provide that an emergency contact number may be provided on the screen. With the appointment system, customers are allowed to sign. However, in some embodiments, customers without appointments cannot sign in for assistance.

In some embodiments, signing in may include entering a customer last name and last four digits of a customer specific identification number, such as a social security number, for example. In this manner, the user interface may be unlocked so the customer can sign in for service. Once a customer signs into the computer in the lobby, the module shows all customers but lists the customers for each section separately. This gives the customer a better idea as to the wait time. Once a customer signs in, that customer appears on the computer screen(s) of the corresponding MPS section.

The MPS sign-in module 310 may include a consolidated customer module so that a person can review and manage all customers waiting to be served in the customer waiting area. This screen is also used to review customers previously served to review the service was provided, the wait time, the technician who served the customer and other issues concerning this customer.

Additionally, some embodiments provide that multiple different reports may be generated, including, for example, customer details by section or collectively (all sections), customer summary reports by section or collectively and average wait time reports by section or collectively. In some embodiments, these reports may be used to track work production, award submissions, evaluations, etc.

Still referring to FIG. 2, the system 200 may include a personnel data tracker 230, which may consolidate and track personnel data discrepancies, automatically generate informational e-mail to military members and send dependency and marital status change notifications to unit leadership. Some embodiments provide that examples of data discrepancies that may be tracked include: family members who require a new military identification (ID) card because it was never issued or has expired; military members who require a new military ID card (e.g., status change); passports that need to be returned to the Passport Administrator due to the military member's pending retirement, separation or because the member recently returned from an overseas assignment; incorrect residence addresses in the Defense Enrollment Eligibility Reporting System (DEERS) or the Military Personnel Data System (MilPDS); children not added to DEERS; marriage or divorce not updated in DEERS; missing Social Security Numbers for family members in DEERS; Servicemembers Group Life Insurance (SGLI) errors to include incorrect addresses, missing beneficiary information, missing unusual beneficiary letter(s), MilPDS coverage doesn't match the SGLI form, distribution of payout doesn't equal 100%, spouse letter not sent, incorrect beneficiaries listed on the SGLI form; incorrect housing allowance code at Finance; virtual Record of Emergency (vRED) errors to include, the form hasn't been updated since arrival to the base, the residence address is incorrect, outdated addresses for individuals listed on the vRED, missing direction to residences, missing contact information on individuals listed on the vRED, marital status is incorrect, spouse or others on the vRED was incorrectly identified as military members. The personnel data tracker 230 may further record and monitor personnel data discrepancies until they are resolved. Some embodiments the user may be directed how to resolve the discrepancy. Some embodiments provide that consolidating personnel data discrepancies may include generating one or more summary and/or statistical reports and/or types thereof.

In some embodiments, the personnel data tracker 230 consolidates and tracks personnel data discrepancies until they are resolved. The personnel data tracker 230 may summarize the problem, indicate what actions need to be taken by the member to resolve the program, and record what actions were taken to resolve those problems. In some embodiments, the personnel data tracker 230 is also used to send dependency and marital status change notifications to unit leadership. For example, a system user in the process of issuing an ID card may discover that the customer is divorced but the divorce is not updated in one or more databases. In such a case, the customer may be informed of the corrective actions for resolving the discrepancy and the discrepancy may be entered in via the personnel data tracker 230.

The personnel data tracker 230 may automatically populate based on the nature of the discrepancy. For example, in the divorce context, a marital status field may be updated incorrectly within one or more of the relevant databases, the personnel data tracker 230 may then automatically populate the problem and action that the customer needs take. Additionally, a message, such as an email or text message among others, may be generated and sent to the customer that informs the customer of the problem and of steps for resolving the problem.

In some embodiments, the personnel data tracker 230 may notify one or more individuals in the command chain of unresolved discrepancies. In some embodiments, notification may determine the discrepancies are unresolved based on a specific temporal threshold. For example, at the end of each month, first sergeants may be notified of unresolved discrepancies (2 weeks or older). The personnel data tracker 230 may consolidate all the open discrepancies into one list. At the end of each quarter, commanders may be notified of unresolved discrepancies (1 month or older). Some embodiments provide that involving unit leadership motivates personnel to resolve open discrepancies.

In some embodiments, one or more databases are also connected and/or linked with the system access hub 210. In this manner, if a customer appears for service, for any reason, the user at the front counter may be alerted that the member has an open data discrepancy. This may be advantageous for several reasons. The first reason is that it notifies the user that the problem and/or discrepancy is being tracked. The second reason is that it provides a methodology for users to remind the customer of the problem. Yet another reason is that if a user is present to resolve the problem, then the discrepancy may be closed out and thus the need to research the issue later may be eliminated.

In some embodiments, the personnel data tracker 230 may track marital status (i.e., marriage and divorce) and dependency change notifications (e.g., child born out of wedlock, divorcee with child, mil2mil couple) to unit leadership. When a marital status change occurs in the Military Personnel Data System (MilPDS), the update generates a transaction register (TR). Each TR may include different required actions. In this case, the user is supposed to forward the TR to unit leadership to inform him or her of the marital status change so various actions can occur (e.g., update recall rosters, create Family Care Plans, etc.). Unfortunately, the TR may be cryptic and thus command personnel may be uncertain regarding what actions need to occur. As such, the personnel data tracker 230 may list all of the actions that need to occur, in detail. The personnel data tracker 230 may also consolidate when the marital status or dependency change occurred, when the notification was done and who was notified.

Some embodiments provide that the personnel data tracker 230 may also generate and send informational e-mails that may be sent to customers that should be tracked. For example, in the context of a single military member who designated his mother as his beneficiary on his life insurance, the member may have gotten married without updating his life insurance naming his wife as his beneficiary. If this member died, the mother would get the insurance proceeds, not the wife. The personnel data tracker 230 can generate informational e-mail to inform the military member of this issue and what actions he needs to take, should he elect his wife as his primary beneficiary.

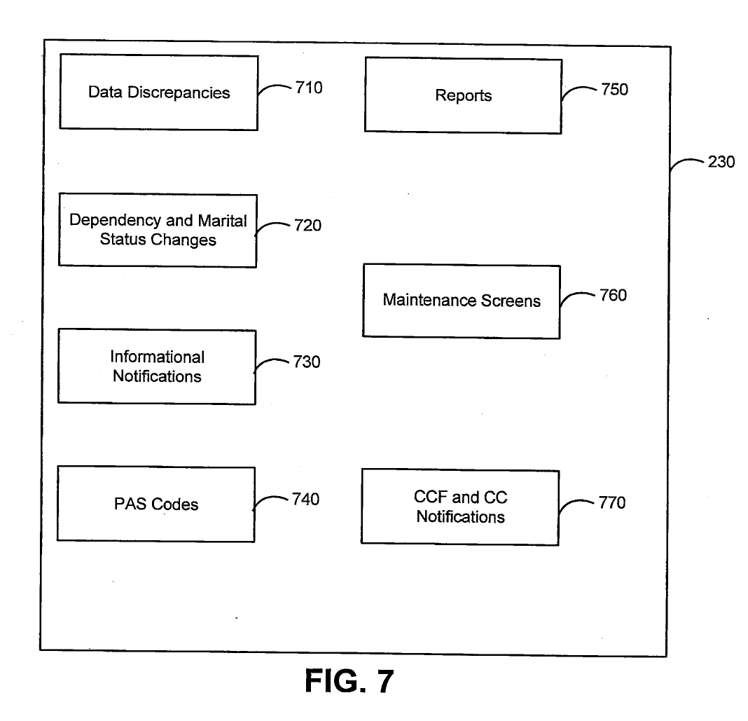

Brief reference is now made to FIG. 7, which is a block diagram illustrating operations, components and/or computer program code modules that may be included in the personnel data tracker 230 according to some embodiments of the present invention. Data discrepancy operations 710 may identify data discrepancies by a user based in data from a user input and/or from an alpha roster module (FIG. 2, 240). In some embodiments, a data discrepancy input form may include, populate and/or be populated using table information. For example, the personnel data tracker 230 may be automatically populated to save time and to avoid typographical errors. Some embodiments provide that the discrepancy can be automatically resolved based on input from the user, while in some embodiments the user may be directed how to resolve the discrepancy. Information stored in the tables may include discrepancy type, which may be identified by a user and may populate the data discrepancy input form. Data discrepancy operations may also be used to populate the alpha roster module with data that may be provided by a personnel systems management module (FIG. 2, 250). For example, in response to a user selecting a customer name from the alpha roster module, a data discrepancy input form and/or one or more notification messages may be automatically populated.

Data discrepancy operations 710 may provide that the data discrepancy input form and/or one or more notification messages may be populated with information corresponding to a military personnel section user that may be selected from an available this thereof. Additionally, data discrepancy operations 710 may provide that the data discrepancy input form and/or one or more notification messages may be populated with problem user history information. Additionally, based on data imported and/or input into the data discrepancy input form, one or more messages may be automatically generated and/or sent to the customer and/or customer leadership personnel including information regarding actions necessary to resolve the data discrepancy problem.

In some embodiments, the personnel data tracker 230 may provide operations corresponding to dependency and marital status changes 720. Some embodiments provide that a user may identify dependency and marital status changes in that the notification message may be automatically generated and sent to one or more leadership personnel. Dependency and marital status changes may be received into the system via a dependency notifications form which may be populated from information stored in one or more data repositories. In some embodiments, dependency notification forms may include, populate and/or be populated using table information. Types of information include dependent status change types in which the user identifies the type of status change and the dependency notifications form is populated automatically.

Operations corresponding to dependency and marital status changes 720 may also be populated by the alpha roster module with data that may be provided by a personnel systems management module (FIG. 2, 250). For example, in response to a user selecting a customer name from the alpha roster module, a data discrepancy input form and/or one or more notification messages may be automatically populated.

Operations corresponding to dependency and marital status changes 720 may provide that the dependent notifications form and/or one or more notification messages may be populated with information corresponding to a military personnel section user that may be selected from an available this thereof. Additionally, operations corresponding to dependency and marital status changes 720 may provide that the dependent notifications form and/or one or more notification messages may be populated with problem user history information. Additionally, based on data imported and/or input into the data discrepancy input form, one or more messages may be automatically generated and/or sent to the customer and/or customer leadership personnel including information regarding actions necessary to resolve the dependency and marital status changes.

In some embodiments, the personnel data tracker 230 may provide operations corresponding to informational notifications 730. Some embodiments provide that a user may identify potential problems in personnel records and a resulting notification message may be automatically generated and sent. Informational notifications may be received into the system via an informational only input form which may also be populated from information stored in one or more data repositories. In some embodiments, information only input forms may include, populate and/or be populated using table information.

Operations corresponding to informational notifications 730 may also be used to populate the alpha roster module with data that may be provided by a personnel systems management module (FIG. 2, 250). For example, in response to a user selecting a customer name from the alpha roster module, an informational only input form and/or one or more notification messages may be automatically populated.

Operations corresponding to informational notifications 730 may provide that the informational only input form and/or one or more notification messages may be populated with information corresponding to a military personnel section user that may be selected from an available this thereof. Additionally, operations corresponding to informational notifications 730 may provide that the informational only input form and/or one or more notification messages may be populated with problem user history information. Additionally, based on data imported and/or input into the informational only input form, one or more messages may be automatically generated and/or sent to the customer and/or customer leadership personnel including information regarding actions necessary to resolve the informational notifications.

In some embodiments, the personnel data tracker 230 may provide operations corresponding to personnel accounting symbols (PAS) codes 740. Some embodiments provide that a user may update PAS codes that may be used to identify a customer's assigned unit and that may be provided by one or more data repositories corresponding to personnel system management. For example, PAS codes may include installation specific data, unit specific data and/or branch specific data. In some embodiments, PAS codes may be sent to an award and decoration module (See, FIG. 2, 260).

In some embodiments, the personnel data tracker 230 may provide operations corresponding to a reports module 750. Some embodiments provide that a plurality of different reports and/or types thereof may be generated and provided to users, customers and/or unit leadership. For example, data may be computed from received and/or stored data and may include open cases, open cases (+3 months, open cases by specified unit, closed cases by date, closed cases by unit, informational notifications, unit leadership dependency notifications, types of late cases (marital status), summary of discrepancies, and/or cases that cannot be resolved, among others.

In some embodiments, the personnel data tracker 230 may provide operations corresponding to maintenance screens 760. Some embodiments provide that maintenance screens 760 may allow a user to update data used in a plurality of different forms. Examples of maintenance screens 760 include screens corresponding to finding types, non-work days, the units served, MPS points of contact, MPS technicians and/or for updating the alpha roster, among others. Data in tables corresponding to these screens may be changed based on present circumstances and may be used to update other screens and/or reports.

In some embodiments, the personnel data tracker 230 may provide operations corresponding to first sergeant (CCF) notifications 770. In the present example, CCF may include a front-line supervisor, unit commander (CC) and may include a senior level of supervision, such as, for example, a commander. In this manner, leadership personnel such as CCF and CC may be notified via the unit notification input form of reports including discrepancies, unit totals, and/or unit totals that are grouped by individual. In some embodiments, the CCF report may include notifications corresponding to discrepancies that have only been open for a predefined first threshold of time. For example, the CCF report may include notifications corresponding to discrepancies that have been open for more than fourteen days. Some embodiments provide that the CC report may include notifications corresponding to discrepancies that have been open for more than a predefined second threshold time that is greater than the first threshold of time. For example, the CC report may include notifications corresponding to discrepancies that have been open for more than thirty days.

In some embodiments, the personnel data tracker 230 may provide that a user may identify potential problems in personnel records and a resulting notification message may be automatically generated and sent. Informational notifications may be received into the system via an informational only input form which may also be populated from information stored in one or more data repositories. In some embodiments, information only input forms may include, populate and/or be populated using table information. Types of information include information only types.

Operations corresponding to informational notifications 730 may be populated from the alpha roster module with data that may be provided by a personnel systems management module (FIG. 2, 250). For example, in response to a user selecting a customer name from the alpha roster module, an informational only input form and/or one or more notification messages may be automatically populated.

Operations corresponding to informational notifications 730 may provide that the informational only input form and/or one or more notification messages may be populated with information corresponding to a military personnel section user that may be selected from an available this thereof. Additionally, operations corresponding to informational notifications 730 may provide that the informational only input form and/or one or more notification messages may be populated with problem user history information. Additionally, based on data imported and/or input into the informational only input form, one or more messages may be automatically generated and/or sent to the customer and/or customer leadership personnel including information regarding actions necessary to resolve the informational notifications.

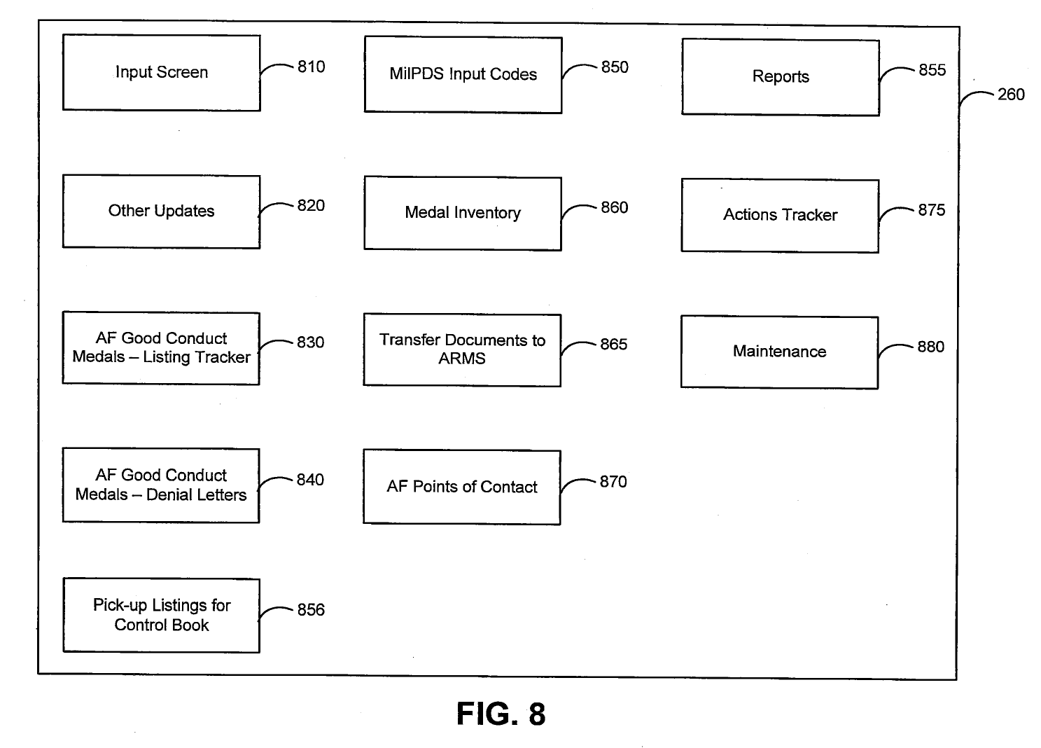

Reference is now made to FIG. 8, which is a block diagram illustrating operations, components and/or computer program code modules that may be included in the awards and decorations module 260 according to some embodiments of the present invention. The awards and decorations module 260 may track the processing of all awards and decorations related functions to include locally generated and incoming decorations and customer service requests. The awards and decorations module 260 may automatically generates award documentation for inclusion in a user's personnel record. Some embodiments provide that Good Conduct Medal denial letters may be monitored and medal inventory may be tracked.

In some embodiments, the awards and decorations module 260 may consolidate awards and decorations into a single module to track processing. The awards and decorations module 260 can quickly produce reports (e.g., monthly corporate metrics, types and numbers of decorations awarded, combat decorations, decorations awarded by unit, etc.). The awards and decorations module 260 is also used to monitor Good Conduct Medal denial letters and to track medal inventory.

An awards and decorations database 260 may be linked to the alpha roster 240. In this manner, if a user is inputting a new decoration, the user would not have to input the customer's information and instead would click the alpha roster icon, then type the first three of four letters of the customer's last name. The user would then double click the customer's name to transfer demographic information into the database (i.e., grade, name, SSN, assigned unit and e-mail address).

In some embodiments, there may be two primary input screens 810: (1) Moody AFB and incoming decorations that need to be processed and (2) Customer decoration requests (e.g., medals posted in ARMS but not MilPDS, such as, for example, marksmanship ribbons, campaign medals, deployment awards, unit awards, etc.)

The input screens 810 have many features. For example, many redundancies are included to prevent errors for mismatched info or missing data. Such redundancies may be provided and/or presented in the form of popup warnings and/or confirmation requests, among others. Additionally, citations and amendments may be printed directly from the database and customer e-mail notification capability may be included. Some embodiments provide that unit pick up information may be listed for each decoration (retaining paper copies is no longer necessary) and forms such as AF Forms 104, may be automatically generated. In some embodiments an Air Force Points of Contact 870 is provided. For example, in the case that an incorrect decoration is received, the Air Force Points of Contact form 870 may be opened and the contact selected by clicking an icon. An email may then be automatically generated and sent to the contact. The Points of Contact form may list phone numbers, mailing addresses and other info. There is also a feature that generates an e-mail for the Points of Contact to review their contact information.

The Air Force Good Conduct Medal (AFGCM) module 830 tracks all listings sent to the units and helps the user to quickly identify which listings have been signed and returned and which have not. The initial monthly e-mail notification may be automatically generated. An Air Force Good Conduct Medal—denial letters module 840 may provide a sample denial letter that a user may process for denials. The user simply clicks an icon and attaches the unit listing. There is also a follow-up e-mail notification system built into the AFGCM module 830. In the AFGCM module 830 there is an AFGCM calculator. The user can enter up to four letters of denial. The calculator computes the number of AFGCMs from entered active duty (EAD) to the day before first denial period, then computes from the day after the denial period to the current day or the day before the next denial period. The calculator removes the manual computation of AFCGMs to ensure the correct number is reflected in MilPDS.

There is also a module for batch updating. For example, responsive to a notification that a particular unit or group of users was awarded a particular medal, that entire unit may be updated in MilPDS using a MilPDS batch update. In some embodiments, a PSM data set may be imported into the database and used to update MilPDS. An input may be submitted that causes the awards to be transferred to the ARMS database.

In some embodiments, the awards and decorations module 260 may include one or more input screens 810 through which the module receives input corresponding to decoration information from a user and may be populated with customer demographic information from the alpha roster. For example, a decoration input form may be used to receive information such as decoration type, alpha roster provided data, the type of service, and/or assigned units, among others. Additionally, many awards may require support documentation, which may be sent to AFPC for inclusion in the customer's official record. In some embodiments, the input screen 810 may operate to digitally transfer all processed awards and decorations into the ARMS module 270. Further, one or more reports regarding awards and decorations corresponding to individual customer's and/or specified units or groups may be generated and sent to various personnel.

Other updates 820 corresponding to specific individuals may be received. For example, awards and decorations from individuals to process may be received via an award or decoration input form. For example, an award or decoration input form may be used to receive information such as decoration type, alpha roster provided data, the type of service, and/or assigned units, among others. For this form, an AF Form 104 is electronically and automatically generated and mailed to AFPC for inclusion into the official record and the updates screen 820 may operate to digitally transfer all processed awards and decorations into the ARMS database. Further, one or more reports regarding awards and decorations corresponding to individual customer's and/or specified units or groups may be generated and sent to various personnel.

The AFGCM listing tracker 830 may provide a command and/or upper level leadership with messages and may track sent and received listings. For example, a monthly roster input form may track a listing that was sent and when the listing is signed by a command and/or upper level leader was returned. For example, an initial notification email with a roster of eligible customers and a sample denial letter may be sent. In some embodiments, reminder notification emails may be sent and may also include the roster of eligible customers and a sample denial letter. An AFGCM denial letter module 840 may determine how many denial letters are received from commanders and compute how many AFGCM's should be in MilPDS based on current and previous denial letters. For example, the AFGCM denial letter module may include a denial letter tracker that may capture denial letter information including name, rank, and denial period, among others. In some embodiments, as AFGCM's are awarded to enlisted members every 3 years if service time is exemplary, an AFGCM calculator may compute how many medals should be posted in MilPDS based on date entered military and the number of previous denial letters. Some embodiments provide that a pick-up listings for control book module 856 may be provided.

A MilPDS input codes module 850 is configured to provide a user with eligibility criteria and MilPDS input information for each award or decoration. This may be advantageous as eligibility criteria for various awards may be complex and confusing and each different award may include different type and award codes. In this manner, the user may quickly identify the award eligibility criteria and corresponding MilPDS codes.

A medal inventory module 860 is configured to provide a user with an inventory of current medals and a predictive indicator of dates and/or quantities for ordering additional medals. In some embodiments, the medal inventory module 860 is configured to provide a summary report indicating stock levels and projected needs.

An Air Force points of contact module 870 is configured to provide a user with points of contact corresponding to every point of contact for awards and decorations. This information may include name, address, email and phone number and may be used to mail decorations or to provide contact regarding a potential problem with the award or decoration. For example, an icon corresponding to the customer may, when actuated, create an email to the point of contact. In some embodiments, information revalidation operations may be included using for example, a color-coded date field to alert the user that the awards and decorations contact information should be revalidated. For example a message may be generated and sent that includes current contact information with a request that such information be revalidated.

In some embodiments, a transfer documents to ARMS module 270 may be provided to digitally transfer processed awards and decorations to the ARMS database.

Some embodiments include an actions tracker module 875 that is configured to generate a message to a unit, group and/or point of contact that includes information regarding a problem and what actions they took to resolve the problem. In some embodiments, an actions tracker input form may receive data from recording monitoring and tracking actions taken to resolve the problem.

Some embodiments include a reports module 855 that may generate a plurality of different reports and/or types reports. Non-limiting examples of such reports include reports corresponding to all decorations, combat decorations, decorations by specified unit, non-recommendations, decorations by individual person, unit awards, processing time, amended orders, AFGCM denials by unit, and/or decorations awaiting pickup by unit, among others. In some embodiments, responsive to selecting particular report, the user may be asked to provide a report period for the requested report.

In some embodiments, a maintenance module 880 may be included that may be updated by a user and may detect changes in data in corresponding tables. The maintenance module 880 may provide a central location for updating multiple different other modules in the overall system. Examples of data, data types and/or operations include decoration names, other awards and decorations, non-workdays, delete blank records, update alpha roster, and/or update users, among others.

Referring back to FIG. 2, the system includes an automated records management system 270 that may be used by all Military Personnel Sections who input and track documents which are mailed to AFPC for inclusion in the official personnel records including, for example, decorations, reenlistment documents, etc. In some embodiments, the Automated Records Managements System (ARMS) may be maintained at the Air Force Personnel Center (AFPC) in San Antonio, Tex. Some embodiments provide that the ARMS system 270 may manage who has digital access to personnel records online (people are authorized to view specific personnel records based on their military role and position). The ARMS database 85 and may manage additions, deletions and changes for those authorized access to ARMS. Additionally the ARMS database may provide operability to quickly and efficiently monitor the flow of paper documents from base-level to AFPC for inclusion in ARMS.

In some embodiments, a main screen may provide multiple MPS section input screens. For example, if Career Development (CD) had some forms to send to AFPC, then the CD user would open and input the documents he or she wanted to send to AFPC. The user would then print out an inventory sheet from this tool, along with the documents, and then provide the package to a user, such as a customer service representative. A user, such as a customer service representative, may ensure that the inventory matches the documents provided before sending the documents to AFPC (along with the documents from the other sections).

In some embodiments, the user, such as MPS personnel, can view when a document was mailed to AFPC. This may be advantageous because users, such as customer service personnel, may not need to be interrupted to research if and/or when a document is mailed. In some embodiments, once a document is mailed, the document may be locked in the database (read only) to prevent anyone from adding and changing input.

Some embodiments provide that the ARMS system 270 includes a “back door” feature that may be password protected to allow a user such as customer service personnel to work other features of the program, such as consolidating all the documents that need to be mailed, accountable mail tracking feature, reports. Examples of such reports include PRDA additions/deletions, forms mailed (by week, by section), forms received, and/or forms mailed, among others. The ARMS system 270 may include an ARMS role administrator module that may track every customer, user and/or command personnel who has been assigned as an agent or has been assigned a role. Some embodiments provide that the ARMS system 270 will alert a user when roles need to be re-validated using, for example, a color coded alert system. In this manner, when the role needs to be revalidated, the user may provide a simple user input by actuating the appropriate icon and the ARMS system 280 may generate and send a message to the person with the role and/or the person who approved/appointed the role for revalidation.

In some embodiments, award and decoration documents may be received into the ARMS system 270 from the awards and decorations module 260.

Some embodiments of the system 200 include a passports and citizenship module 290 that may track and monitor passport and visa applications and track citizenship actions. In some embodiments, the passports and citizenship module 290 includes a unit waiver letter module. The passports and citizenship module 290 may include and/or access a database that includes a data collection form for retrieved passports. In addition to storing the information in the passports and citizenship module 290 for historical purposes, the passports and citizenship module 290 may automatically generate letters that are required to be provided to the Department of State. In some embodiments, such documents may accompany the passports mailed to Department of State.

Some embodiments provide that the passports and citizenship module 290 may track the number of individuals requesting an official passports visas and individuals applying for US citizenship. In some embodiments, passport customers may sign in for service along with other customers. This may provide an accurate account of the number of customers served for passport related reasons, regardless whether they complete an application or not. In some embodiments, a passport administrator may have their own office. In some embodiments, the system 200 may alert the passport administrator immediately if a customer has signed in for passport related service. In this manner, a formal communication to the passport administrator may be unnecessary.

The passports and citizenship module 290 may provide individual tracking for each customer applying for a passport. Additionally, alpha roster information corresponding to the customer may be quickly accessed and/or transferred to the passports and citizenship module 290 database. In some embodiments, the passports and citizenship module 290 includes automatic message generators that are activated responsive to receiving an input from a user. Some embodiments provide that the message may include information that a passport has been received and instruction regarding how to pick up the passport.

The passports and citizenship module 290 database may include the date a passport was picked up and a date the visa was picked up to include the person picking up the items. The passport administrator can quickly identify which passports/visas are being held and how many days it has been since the passport was received from the Department of State (DoS).

The passports and citizenship module 290 database may include a Unit Waiver letter module in which letters can be attached to the database for quick reference. For example, waiver letters are consolidated in one section so renewal dates can be closely monitored, since letters may only be valid for a predefined time period (e.g., 3 years).

The passports and citizenship module 290 database may further include a data collection form for retrieved passports (e.g., family members transferring from an overseas location; military members retiring or separating). In addition to collocating the information in a single repository for historical purposes, the passports and citizenship module 290 may automatically create two separate DoS letters, which accompany the passports mailed to DoS.

The passports and citizenship module 290 may provide a plurality reports including, but not limited to an audit report that is used to check for missing information in the database, passport applications received for processing, passports sent to Department of State (DoS), visa reports, DoD processing time, unit pick-up roster, passport by unit, and/or passport by country, among others.

In some embodiments, the system 200 includes a personnel systems management/client support administrator (PSM/CSA) module 250 that operates to track work requests (date, time contacted, response time, type of service provided and problem resolution), product requests and system outages. The PSM/CSA module 250 includes a trouble log that tracks all work requests and problem resolutions. The PSM/CSA module 250 may monitor who has access to various systems and may include operations that quickly disseminate information to all authorized users.

In some embodiments, the PSM/CSA module 250 may be self populated with demographics (name, grade, unit, e-mail and phone) of the customer because all customers are pre-loaded into the unit (Service Personnel) when they are assigned thereto. Responsive to a customer requesting service, the customer data may be accessed via a user interface selection tool such as a drop down menu. Some embodiments provide that the PSM/CSA module 250 may capture the data including customers supported by CSA and by PSM (MilPDS and DCPDS), PSM and CSA work requests, Information Assurance Training, System Status of MilPDS and Civilian PSM, non-routine FOIAs, military and civilian PSM queries, and/or PSM and CST training, among others.

In some embodiments, the PSM/CSA module 250 includes a service personnel screen through which a blanket message can be sent to all “Active MilPDS Account Holders,” all “Active DCPDS Account Holders,” and/or all “Active CST Accounts.”

Some embodiments provide that the PSM/CSA module 250 includes and/or accesses a database that tracks and monitors Defense Joint Military Pay System (DJMS) rejects to include details corresponding to the error, who is assigned as the MPF OPR and what actions were taken to resolve the problem. In some embodiments, automatic message notifications are built into the form (initial notification, over 2 days, and status check).

Some embodiments provide that the PSM/CSA module 250 may provide a plurality of different types of reports including Active MilPDS users, active DCPDS users, type of work request, PSM requested reports, and/or G-series orders, among others. In some embodiments, one report may consolidate and identify DJMS errors and trends. The report may help PSM identify training gaps.

Some embodiments of the system 200 include an alpha roster module 240 that may include operations and/or data for quickly identifying a military member without having to open a traditional spreadsheet or file repository. The alpha roster module 240 may be used to support multiple system modules including the personnel data tracker 230, the system access hub 210, and/or the awards and decorations module 270.

Some embodiments provide that the alpha roster module 240 may be provided to all users from the PSM. When a user needs to look up information corresponding to a customer, data such as grade, name, SSN, Unit, Office symbol, DAS, marital status, e-mail, duty phone, SGLI amount and/or effective date of the data, may be retrieved using the alpha roster module 240. In some embodiments, when a customer requests to change SGLI information, the SGLI amount can be verified via the alpha roster module 240. Some embodiments provide that the user may only enter a portion of the customer last name before a list of possible customers is displayed to the user. The user may then select the correct customer name and all of the relevant customer information is retrieved and displayed using the alpha roster module 240.

In some embodiments, the alpha roster module 240 may be used to populate data corresponding to other ones of the components of the system 200, which may improve efficiency and accuracy by avoiding typographical errors made by users, customers, and/or other personnel, among others. Some embodiments provide that examples of populated data may include transferring grade, name, Social Security number, unit and email address to the personnel data tracker module 230, the awards and decorations module 260 and passports and citizenship module 290; transferring grade, name, Social Security number, unit, email address, Servicemembers Group Life Insurance (SGLI) effective date and amount to the DEERS plus module 211.

Some embodiments provide that the system 200 includes a customer care surveys module 300 that is operable to consolidate, monitor and track returned customer surveys that may be generated by other ones of the components in the system 200. In some embodiments, the customer care surveys module 300 tracks customer input and responses to those surveys. Some embodiments provide that the customer care surveys module 300 is operable to generate a plurality of different reports and/or types thereof. In some embodiments, multiple ones of the modules and/or databases in the system 200 may automatically generate and/or send surveys to customers once the service to the customers is complete. Examples of such modules and/or databases include but are not limited to the system access hub 210, the PSM/CSA module 250, DEERS Plus module 211 and/or the passports and citizenship module 290, among others.

Some embodiments provide that each survey asks the customer to rate example areas including quality of service, courtesy of the staff, knowledge level of the staff, appearance of the staff, waiting time and/or condition of the facility, among others. In some embodiments, the surveys may be returned to a team leader for review and input into the customer care surveys module 300. Some embodiments provide that if a very positive or very negative critique is received, the customer care surveys module 300 may generate a pdf file of the critique and attach it to a message so that it can be sent to the appropriate party for a response.

In some embodiments, a plurality of reports and products may be included analyze the results for MPS management, corporate and higher headquarters. Reports may include reports of each individual user or section, overall survey results, dissatisfied customers, and/or the number of people who required a return visit, among others. At the end of each month, each user may receive a consolidated report of the comments received on him or her for the month. This feedback lets the user know his strengths and weaknesses and provides leadership feedback.

Still referring to FIG. 2, a personnel data integrity module 220 may be operable to consolidate, monitor and track various Personnel audits performed throughout the year. The personnel data integrity module 220 may include and/or access a database and may generate an audit schedule and specific direction on how to conduct the audit by using a combination of reports generated by the other modules in the system 200 and reports generated by PSM. The personnel data integrity module 220 tool identifies potential data entry problems (e.g., Air Force wide, other AF bases and local). Some embodiments provide that examples of data entry problems that may be identified may Afghanistan and Iraqi campaign medals audit, Air Force Good Conduct Medal (AFGCM) base-wide analysis, AFGCM denial letters audit, first-term airmen decorations audit, Air Force Expeditionary Medal audit, National Defense Service Medal and Global War on Terrorism Service Medal audit, monthly open data discrepancy audit for first sergeants, quarterly open data discrepancy audit for unit commanders, DD Form 1172-2 remarks section audit, DEERS accuracy audit, lost and stolen ID card audit, family member ID card audit for military couples, scanned documents in DEERS audit, ID cards for family members of single and divorced members audit, family care plans crosscheck, Management Assessment Product audit, MilPDS address audit, formal name audit in MilPDS, marital change unit notification audit, identify members who don't have SGLI covers, identify members with less than full SGLI coverage, audit of SGLI of newly married or divorced.

In some embodiments, In addition to identifying personnel data discrepancies, the personnel data integrity module 220 may also include many other initiatives integrated into the Personnel Data Integrity module 220 or database therein. For example, every 6 months an alert may be provided to Airmen who do not have SGLI coverage (Info Only) and inform them what they need to do, in the event they want to start their SGLI. In some embodiments, this may be done periodically, for example every 6 months, due to the rotation of the base populace and the change in marital status.

Some embodiments provide that the personnel data integrity module 220 helps to record, track and monitor many different audits that may be conducted throughout a year. The audits performed usually involve data collected corresponding to other modules in the system 200. Some embodiments provide that each one of the audits identifies which reports to produce and what actions need to be accomplished.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the embodiments disclosed herein, and that modifications to the disclosed embodiments, as well as other embodiments, are intended to be included within the scope of the appended claims. The present invention is defined by the following claims.

What is claimed is:

1. A computer implemented method, comprising operations as disclosed herein.

2. A computer program product, comprising a non-transitory computer readable storage medium storing computer readable program code that, when executed by a processor of an electronic device, causes the processor to perform operations as disclosed herein.

3. A system comprising modules, components and/or devices as disclosed herein and configured to perform operations as described herein.
